(19) United States
(12) Patent Application Publication
(10) Pub. No.: US 2008/0296947 A1
(43) Pub. Date: Dec. 4, 2008

(54) Chair Device

(75) Inventor: Michael Harris Galumbeck, Abingdon, MD (US)

Correspondence Address: NEWMAN LAW OFFICES, 888 16TH STREET, NW, SUITE 800, WASHINGTON, DC, 20006, US

(73) Assignee: GHN Technologies, LLC

(21) Appl. No.: 11/854,823

(22) Filed: Sep. 13, 2007

Related U.S. Application Data
(60) Provisional application No. 60/941,491, filed on Jun. 1, 2007.

(51) Int. Cl. A61G 5/14

(52) U.S. Cl. 297/326

(57) ABSTRACT

A chair device which can consist of a multiple part secondary seat mechanism which can be incorporated into an elevator chair which can also have an anti-tipping design feature, and related method. Various exemplary embodiments include one or more of the following: a seat assembly mounted on a support frame which includes an occupant supporting seat having a rear seat section; a seat back connected to and extending upwardly from the rear seat section and a front seat section which extends substantially across the extent of the rear seat section and which is pivoted to the rear seat section; a seat drive unit that drives the seat assembly from a down position where the front and rear seat sections extend in the same first plane to a second raised position where the rear seat section remains in a second plane parallel to said first plane while the front seat section angles downwardly and outwardly; and subsequently the seat drive unit drives the seat assembly to an uppermost position where the rear seat section maintains substantially the same said plane and the front seat section is perpendicular to the ground.

This application claims both the benefit of an earlier filed provisional application, filed Jun. 1, 2007, identified as Application No. 60,941,491, and an earlier filed PCT application, filed Aug. 10, 2007, identified as Application No. PCT/U.S.07/75715, which claimed the benefit of said provisional application.

### BACKGROUND OF THE INVENTION

1. Field of the Invention

This invention relates generally to a chair

2. Description of Related Art

It is often necessary to provide assistance to a person who is attempting to move from a sitting or standing position into or out of a chair. Age, infirmity, or various disabilities often render it difficult for persons to rise into or out of a chair from a sitting or a standing position without assistance.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### BRIEF SUMMARY OF THE INVENTION

In light of the present need for a chair device, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

In moving an occupant of a chair from a sitting to a free standing position, it is believed to be desirable that these positions and those in between provide adequate and comfortable support if the chair is to function effectively. The chair is sometimes designed to distribute only the requisite pressure to the back, buttocks and thighs to a user when making the sit to stand transition. Also, sometimes as the chair moves an occupant from one position to another, it is believed to be desirable that the chair backrest not apply shear stresses to the back of an occupant.

It is believed to be desirable that, as the chair rises to support the weight of the occupant in the standing position, the folded front section of the chair seat does not unnecessarily exert stresses against the upper leg of the occupant. Accordingly) it is believed to be desirable that the chair be designed in such a way as to provide maximum stability for the occupant while maximizing safety considerations both to the occupant and to any bystanders.

Embodiments that transition an occupant from a seated to a standing position, upon rising, sometimes tip the occupant or the chair forward without regard to the stress placed on the occupant's musculoskeletal frame or to the occupant's stability upon exiting the chair.

Embodiments that move occupants upwardly from a sitting position with obstruction from the chair or parts thereof often fail to eliminate these impediments to maximizing occupant safety and stability. For example, some embodiments require an occupant to slide forward over a sloping or projecting seat.

Embodiments that transition an occupant sometimes incorporate features that could cause pinching to a bystander or occupant, that individual's fabric, skin or anatomical parts, and thus fail to remove pinch points.

Some embodiments are wheelchairs that raise an occupant from a sitting to a standing position and support the occupant in the standing position. Unfortunately, such embodiments are sometimes designed for continued occupant support in a standing position and not to facilitate transition from the chair to a free standing, unsupported position.

It is desirable to elevate occupants of a conventional chair safely and comfortably. However, various embodiments push occupants out of the chair without regard to safety, comfort, or even appearance.

Some embodiments include one or more components a chair device that can be incorporated into an elevator chair as seen in U.S. Pat. No. 5,984,411 (hereinafter “the '411 patent”) entitled “Elevator Chair,” granted Nov. 16, 1999, which is specifically incorporated herein by reference. In the '411 patent, the mechanism moves between different vertical positions enabling a user to enter, to transition, and to leave the chair with some safety, stability, and comfort.

Various embodiments provide a secondary seat mechanism which includes a supported foam wedge or other compressible material such as cotton batting, between front and rear sections. In the down position, the covered foam wedge, mounted between the front and rear sections, will provide one piece seat comfort.

Various embodiments provide a secondary seat mechanism such that, in the uppermost position, there exists a substantial decrease or elimination of stress against the legs, and an increase in the stability of the occupant.

Various embodiments provide a secondary seat mechanism which reduces or eliminates the risk of pinching, such as squeezing or binding of an occupant's or bystander's fabric, skin, anatomical parts or any other object.

Various embodiments provide a secondary seat mechanism that is directed to a chair that possesses an anti-tipping design feature.

Various embodiments provide a secondary seat mechanism that aesthetically appears as a conventional chair or seat instead of a mechanical or medical device.

### BRIEF DESCRIPTION OF THE SEVERAL VIEWS OF THE DRAWINGS

In order to better understand various exemplary embodiments, reference is made to the accompanying drawings, wherein:

FIG. 1A is a view in partial perspective showing an exemplary chair in a down position;

FIG. 1B is a view in partial perspective showing an exemplary chair in an uppermost position;

FIG. 2 is a view in right side down position showing an exemplary chair;

FIG. 3 is a view in left side raised intermediate position showing an exemplary chair;

FIG. 4 is a view in right side uppermost position showing an exemplary chair;

FIG. 5 is a view of unconnected right front and rear side plates of an exemplary chair;

FIG. 6 is a view of connected right front and rear side plates when an exemplary chair is in the down position;

FIG. 7 is a view of connected right front and rear side plates when an exemplary chair is in the uppermost position;

FIG. 8 is a cross-sectional view of a right side plate of an exemplary chair;

FIG. 9 is a view of connected right front and rear side plates when an exemplary chair is in the down position;

FIG. 10 is a perspective of a front frame of an exemplary chair;

FIG. 11 is a perspective of connected primary and secondary liners of an exemplary chair;

FIG. 12 is a perspective of wedge units supported by secondary wedge support members of an exemplary chair;

FIG. 13 is a fragmented view of a right side seat of an exemplary chair in the down position with the wedge unit supported by secondary wedge support member shown out of plane to accentuate the separate elements;

FIG. 14 is a front view of an exemplary chair in the uppermost position; and

FIG. 15 is a flow chart of an exemplary method of assisting a person to stand from a chair.

### DETAILED DESCRIPTION OF THE INVENTION

Referring now to the drawings, in which like numerals refer to like components or steps, there are disclosed broad aspects of various exemplary embodiments.

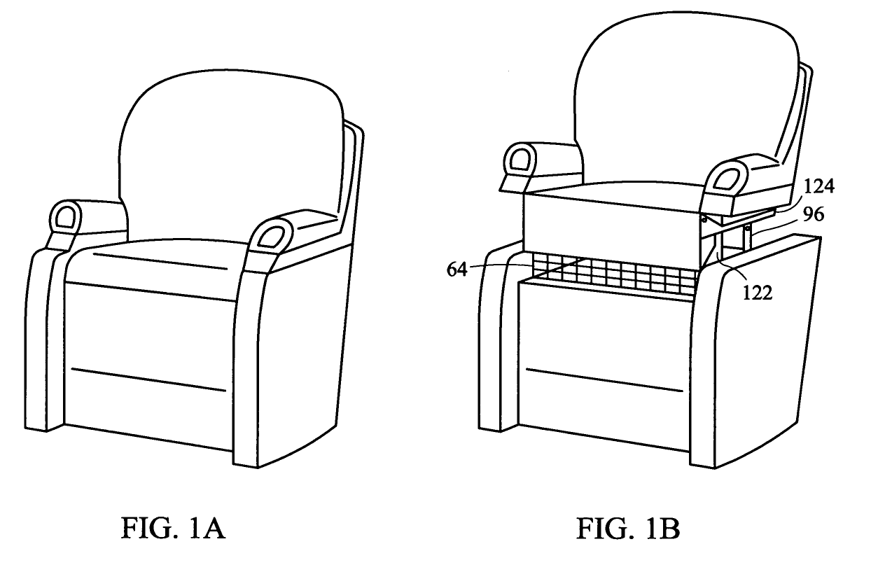

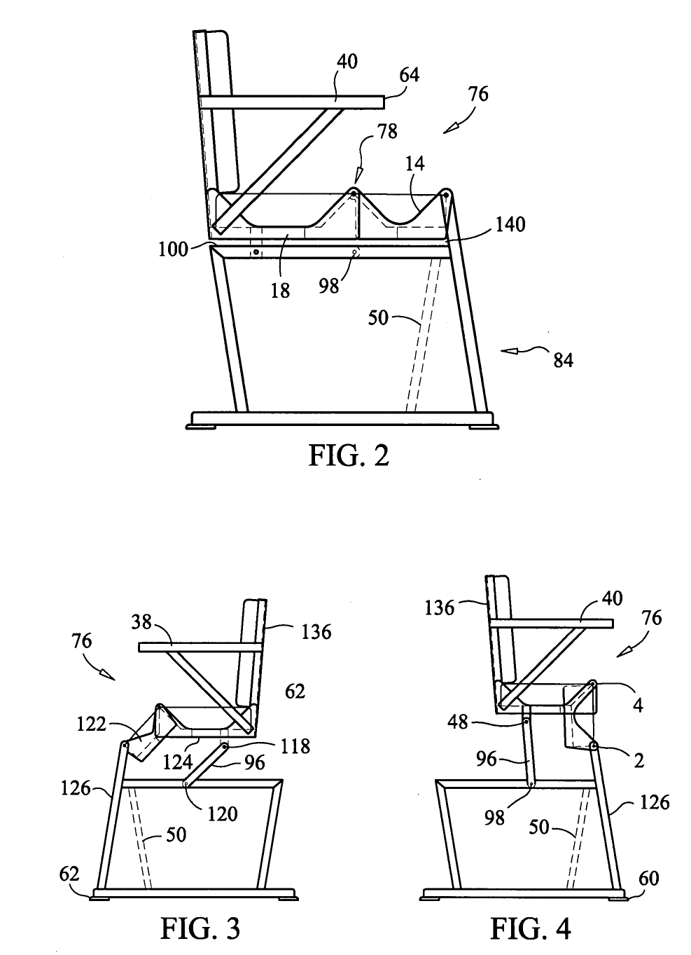

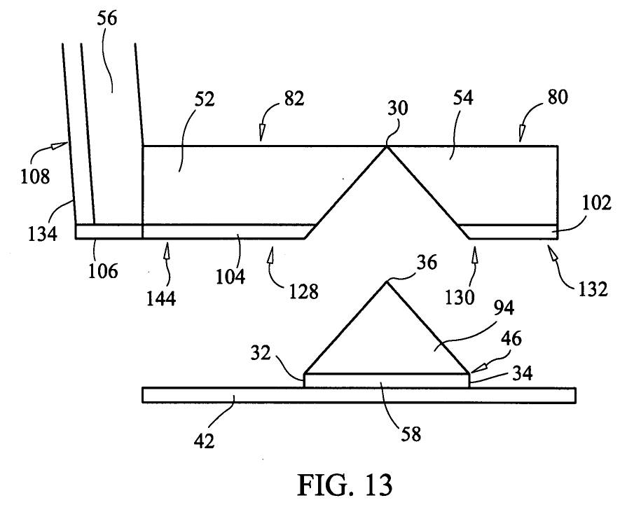

Exemplary embodiment generally seen upholstered in FIGS. 1A and 1B generally seen at 76 in FIGS. 2-4, are a chair which can, in various embodiments, consist of a multiple part secondary seat mechanism which can be incorporated into an elevator chair which can also have an anti-tipping design feature. The multiple part secondary seat mechanism is formed from a seat assembly 78 as seen in FIG. 2 having one or more sections with a wedge unit 46 as generally seen in FIG. 12.

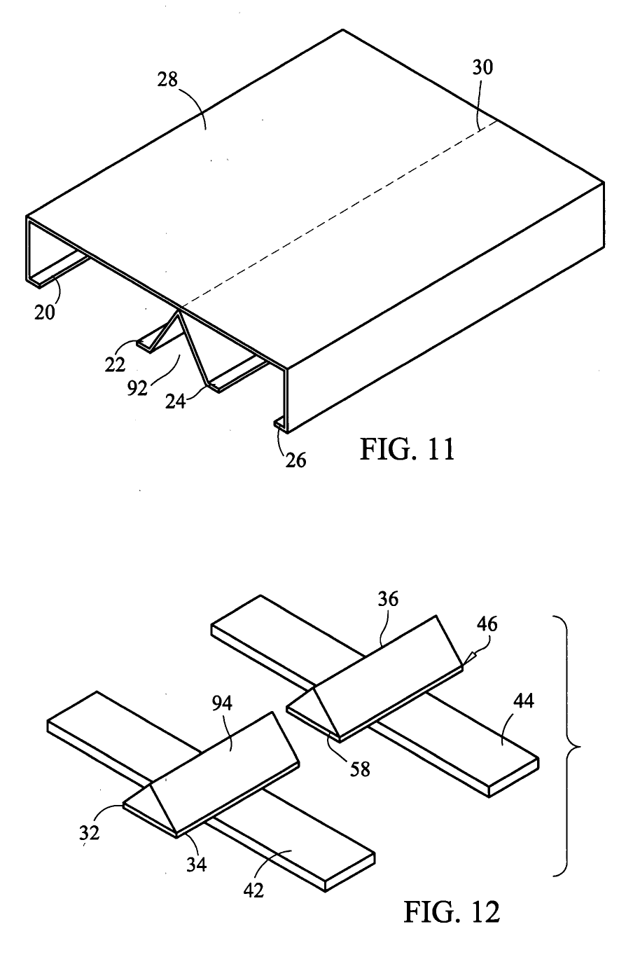

In various embodiments with multiple sections, there exists a front section 80 and a rear section 82 as seen in FIG. 13, both of which are supported in various embodiments by seat sections of different depths, generally seen by a front frame 110 in FIG. 10. The front and rear sections meet transversely across the back and front section edges, respectively, along 30 as seen in FIG. 13, which is also a continuous collection of transverse attachment points of a primary liner 28 and secondary 92 liner as seen in FIG. 11, resulting in a chair with no visible or actual break in the seat covering, which could be fabric, vinyl, leather, a composite, or almost any material.

Various embodiments contain components that have mirror images of, or identical to, the same components on opposite sides of the chair.

In various embodiments, the front frame 110 as seen in FIG. 10 is a substantially rectangular section with a front bar 66 and a rear bar 68 connecting front left 122 and right 14 side plates at the junction of its angled lip 74, respectively, cross-sectionally shown in connection with 70 in FIG. 8, which longitudinally spans most of the side plate as seen in FIG. 10. Said frame 110 may support a front 102 platform as seen in FIG. 13, made of wood in various embodiments, which further supports and secures a front section foam or cushion, generally known as padding 54 or where said frame directly supports and secures said wood, padding, and covering.

In various embodiments, as seen in various Figs., opposite said frame is a rear frame having similar bars that connect rear left 124 and right 16 or 18 side plates, said combination of rear plates being mirrored components, that too have angled lips that also form a substantially rectangular section. The rear frame, which is made of wood, metal or composites, in various embodiments may also support a rear 104 platform which further supports and secures a rear section foam or cushion, or generally known as padding 52 or where said frame directly supports and secures said padding.

The rear seat section is sometimes deeper than the front seat section, but these sizes can be modified. Multiple modes exist where the transverse of the top of the front padding or section or the transverse or vertical face of either padding can be increased with framing or padding or both. These changes then change the corresponding side plates' design to allow sufficient clearance to eliminate pinching during chair use in some embodiments.

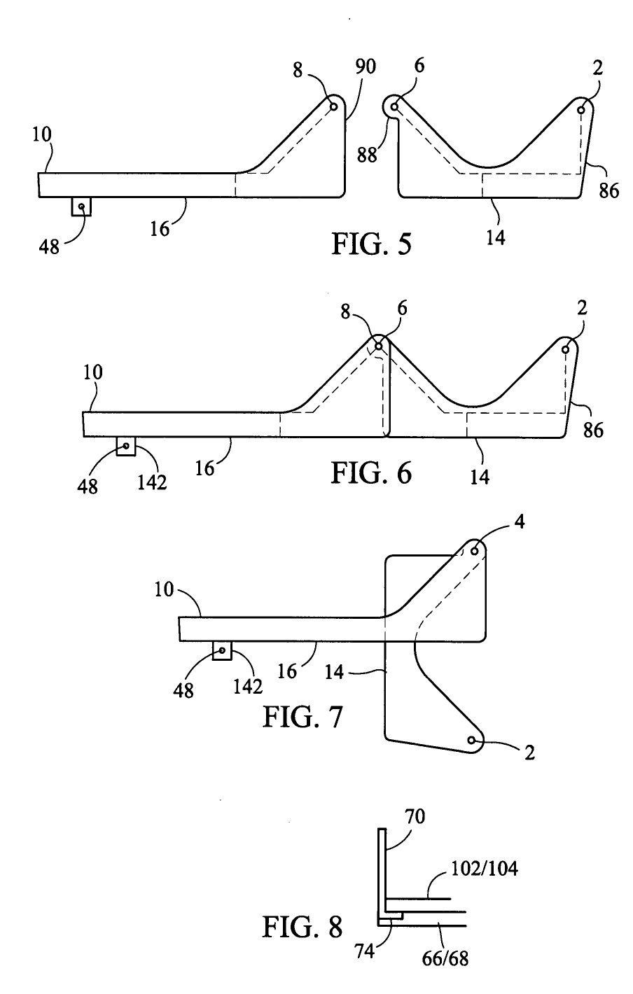

Through its rear connection pivot point 6 contained in a rear preferably circular projection 88, a front side plate as seen in FIGS. 5-6 (and unlabeled in FIG. 7) connects to a rear side plate through its front connection pivot point 8 to form a connection 4 as seen in FIG. 7, preferably by bolting and thus securing front and rear frames. There is an overlap at the junction of the rear and front side plates to eliminate pinch points in either the down or up position.

The side plate is constructed from almost any material, preferably aluminum but including metal, metal alloy, or plastic, welded or combined. The front side plate has a front angled edge 86, which in various embodiments contains a pivot point 2 while exposing less plate which will also decreases a chance of pinching.

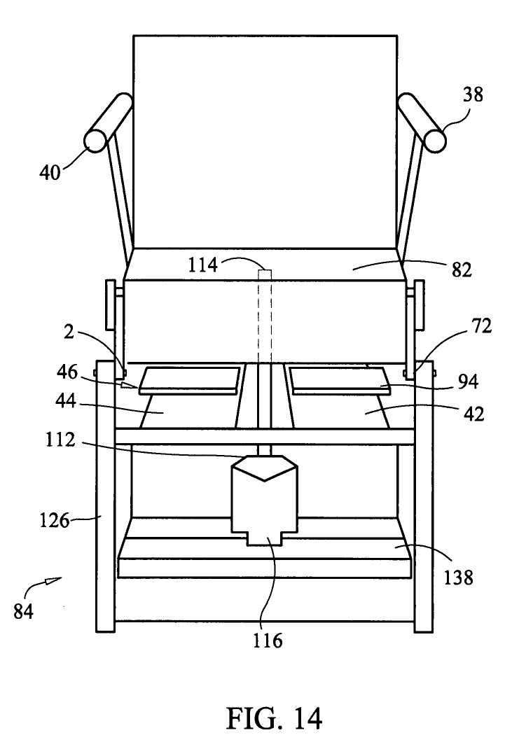

Said front plate connects in various embodiments by bolting to a front leg 126 of a base 84. As seen in FIG. 14 the seat assembly preferably contains two pivot points but may have more.

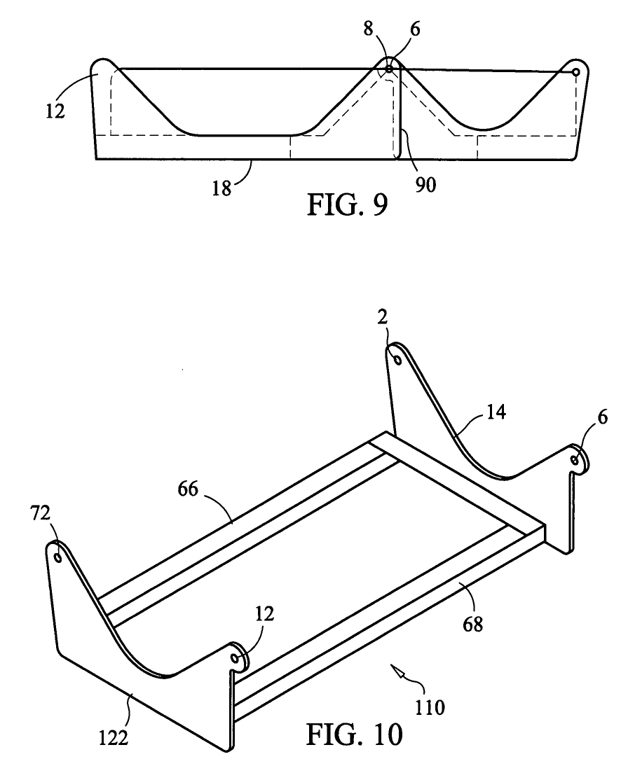

As seen in FIG. 9, a rear side plate 18, and corresponding mirror side plate, has a rear edge 12 for side plate securing to the back section of the chair when it is made of almost any non-wooden material; whereas a wooden base preferably has a side plate 16 with an abbreviated edge 10 as seen in FIGS. 5-7. For any rear side plate, its front edge 90 is in various embodiments perpendicular to the base of said plate, such design eliminating pinching during chair use.

The seat sections are connected to the base 84 generally through five points, which include the top of the actuator connection 114 as seen in FIG. 14, which projects downward below the rear section 82, the forward left 72 and right 2 pivot points, and, as seen in FIGS. 3-4 the top left 118 and right 48 stabilizing link pivot points, which are contained in a projection 142 as generally seen in FIG. 6. Said stabilizing link pivot points or similar mechanism, which prevent the seat from rocking, preferably are attached to the bottom portion of a side plate to eliminate the risk of pinching.

As seen in FIG. 3-4, each of the bottom left 120 and right 98 stabilizing link pivot points and each of said top stabilizing link pivot points, which are situated preferably anterior to said bottom pivot points, are connected by identical stabilizing links 96 on each side. The stabilizing link pivot points can be situated at different coordinates longitudinally along the side plate to ensure the lack of pinching. In the down position, said top stabilizing link pivot points preferably displace to the same plane as the top edge 100 of side of base to prevent pinching as generally seen in FIG. 2.

As seen in FIG. 12, the wedge unit 46, which may be comprised of foam, composite or other known material 94 in a preferably triangularly shaped wedge member, has a primary wedge support member 58. Said wedge unit must allow for movement of the actuator 112 (see FIG. 14) and any related parts, which together is generally considered a drive unit; said drive unit includes other known power sources such as a gas spring or similar device. This allowance for actuator movement results from using multiple foam wedge units as seen in FIGS. 12 and 14 or one foam wedge unit with a portion removed. The primary wedge support member preferably has flat edges 32 and 34 to allow for secondary liner 92 and frame clearance. To support said wedge unit, it is mounted on secondary wedge support member 42 and 44.

Said support members need not be individual pieces but can be any platform that supports said wedge unit but also allows for said actuator, which is connected to horizontal support surface 138 at 116 as seen in FIG. 14, and for either stabilizing link 96, as seen in FIGS. 3-4, to move unimpeded. Said wedge unit provides one piece seat comfort when the chair is in the down position as seen in FIG. 13 where said unit's apex 36 meets 30.

Referencing FIG. 13, the primary liner 28, as seen in FIG. 11, wraps over the top of the foam, and at various attachment points the rear edge of primary liner 20 is preferably attached to the rear platform 104 transversely along 144, and the front edge of primary liner 26 is preferably attached to the front platform 102 transversely along 132. The secondary liner 92, which helps the foam retain its shape, wraps under the foam, and at various attachment points the rear edge of secondary liner 22 is preferably attached to the rear platform 104 transversely along 128, and the front edge of secondary liner 24 is preferably attached to the front platform 102 transversely along 130. The liners, preferably made of canvas or sail cloth and therefore serve as reinforcements, are attached to each other preferably by stitching or heating along the transverse plane 30 of said liners. In another embodiment, the primary and secondary liner can be made as one piece.

As seen in FIG. 14, left 38 and right 40 arm rests project outwardly from the back rest frame 136 (see FIGS. 3 and 4), which is a substantially rectangular frame containing back rest foam or cushion, generally referred to herein as padding 56. Multiple modes exists where said arm rests may be connected to the rear portion of the chair seat or where said arm rests can be further secured by cross beams, which could be attached to the rear of side plates. Said arm rests sometimes rise with the chair to help stabilize the occupant as seen in FIGS. 1A-4.

To raise the chair from the down position as seen in FIGS. 1A and 2 to a second raised position as seen in FIG. 3 and then to the uppermost position as seen in FIGS. 1B and 4 an independent drive unit control toggle switch can be provided on, or alternatively in, each arm rest. This is useful for occupants missing an arm or hand to control the use of the chair.

Said drive unit control switches are connected in known manner between a power supply and said drive unit. In another embodiment, the arm rests are supported by posts secured to a rear side plate or rear section. The subject matter described herein may also be placed in a chair where substantially the entire chair base rises.

The base frame of such a chair that has a multiple part secondary seat mechanism with an anti-tipping design feature can be comprised of metal, wood, or any material capable of withstanding stress. Where the base is a wooden frame the entire chair can be upholstered with fabric as seen in FIG. 1, which will help prevent the chair from appearing as a medical device. Where the base is any material other than wood, fabric is generally used where padding exists but may be used on almost any portion of the chair.

The base of the chair contains the actuator, which extends the chair upwardly from the horizontal support surface 138, and other operating functionalities such as electrical lines, which are hidden from view by a front cover panel 50 as seen in FIGS. 3-4. Secured to the sides of the base 84, as seen in FIG. 14, said horizontal support surface, preferably made of aluminum, should preferably not touch the surface beneath said horizontal support surface, a design which prevents rocking. Other known methods for extending the chair upward may be used.

As seen in FIGS. 3-4, the left 62 and right 60 anti-tipping projections indicate that the front edge of the base must project beyond the front edge of the seat. This may be accomplished by extensions or by design elements. Said projections must extend beyond either forward seat pivot point, seen generally at 2.

As will be noted from FIGS. 2-4, when the actuator is activated to raise the seat assembly from a down position to a second raised position and then to its uppermost position, the front seat section 80 (see FIG. 13) is drawn downwardly about the forward pivot 2 while the rear seat section and the seat back remain substantially in the sitting position. The front seat section and the front section padding angle outwardly from the connection 4 to raise into a straightened position the upper leg of an occupant.

The activation of the drive unit also extends the actuator or any related parts by moving the chair to any position. The preferred embodiment has the actuator attached to the rear seat section; in another embodiment, the actuator may be attached to both said rear and front seat sections or only to said front section. The rear seat cushion 52 supports the buttocks and hip area of a user eliminating the need to slide forward when exiting the chair.

It should be apparent that, as the rear seat section moves, said rear section has been positioned to receive the user's weight. Furthermore, it is important to note that the user's hip section and back are still retained substantially perpendicular as they are in a sitting position, so that the user's buttock is not driven forward as the seat assembly rises from the down or to any other position. If desired, a stop may be provided on almost any part of the chair to stop the seat assembly in the down or any raised position.

Whenever components separate and come back together, various embodiments have a gap 140, as seen in FIG. 2, of approximately one-inch to prevent fingers or other extremities from getting pinched or squeezed. To enhance the appearance of the chair said gap may be filled with foam padding. For enhanced safety and aesthetics, material such as mesh or cloth, generally seen at 64 in FIG. 1B, could be attached to the underside of the seat assembly. During raising of the chair, said material will fill any gap underneath the front seat cushion by flipping up or by some other known manner.

Another embodiment of the present invention exists where the rear frame foam 52 extends to the back of the chair to the back rest support 134 (see FIG. 13). In this embodiment, the primary liner is stapled in different positions which may require a larger liner. Where the base is wood, the rear platform 104, when used, extends to the back rest support 134, said back rest support which may or may not be used, with extending support 106. In another embodiment, the back rest of the chair back component 108 can be vertical or preferably backward to add additional comfort and to help prevent tipping when in the up position.

Another embodiment of the present invention exists where the present invention is reinforced and re-dimensioned with a more powerful actuator for use for those suffering from obesity. Still another embodiment of the present invention exists where the present invention is designed for use in existing chairs, including those found in airplanes, trains, theaters, offices, or almost any location and those used in transferring or transporting an occupant.

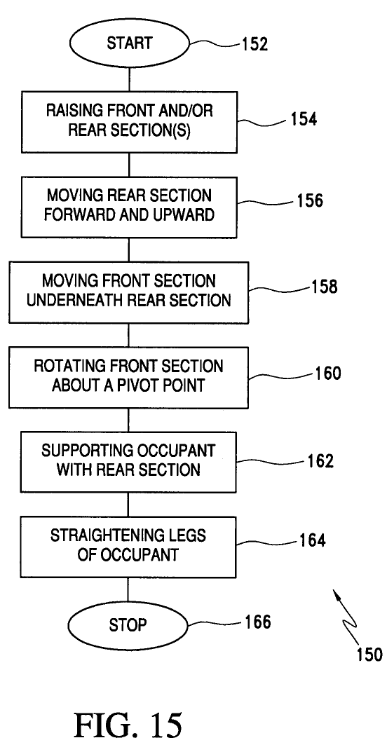

FIG. 15 is a flow chart of an exemplary method 150 of assisting a person to stand from a chair. The method 150 starts at step 152 and then proceeds to step 154.

In step 154, the front and or rear sections of the chair are raised. In other words, it should be apparent in one embodiment, just the front section is raised. Similarly, it should be apparent that, in another embodiment, just the rear section is raised. Likewise, it should be apparent that, in various exemplary embodiments, step 154 includes raising both the front and the rear sections.

In various exemplary embodiment, an occupant of the chair actuates a drive control on an arm rest of the chair in order to cause the raising of the at least one of the front section and rear section in step 154. Further, as noted elsewhere herein, when the front and/or rear sections are raised, the chair does not tip or wobble.

Following step 154, the method 150 proceeds to step 156. In step 156, the rear section is moved forward and upward. Next, in step 158 the front section is moved underneath the rear section. It should be noted that, in various exemplary embodiments, steps 156 and 158 are omitted.

Next, in step 160, the front section is rotated about a pivot point. It should be apparent, when the front section is rotated about a pivot point, support for an occupant of the chair previously available to the occupant from the front section may be partially or completely lost. Thus, in step 162, the occupant of the chair is supported by the rear section.

In step 164, the legs of the occupant of the chair are straightened. As described in greater detail elsewhere herein, in various exemplary embodiments, the occupant of the chair remains in an upright position such that a torso of the occupant is not tipped forward while the legs of the occupant of the chair are straightened. Likewise, in various exemplary embodiments, the occupant of the chair achieves a free standing position that is unsupported by the chair.

Similarly, in various exemplary embodiments, the occupant stands from the chair without being pinched by any part of the chair. It should be apparent that when using any of the various exemplary embodiments in any position, the occupant (or any bystander) enjoys a reduced or eliminated risk of pinching. Following step 164, the method 150 proceeds to step 166. In step 166, the method 150 stops.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A chair device, comprising:
a rear seat section;
a front seat section, in communication with said rear seat section;
a drive unit, in communication with at least one of the rear seat section and the front seat section, wherein said drive unit is configured to raise and lower said at least one of the rear seat section and the front seat section;
arm rests in communication with said rear seat section;
a wedge unit configured to fit underneath said rear seat section and said front seat section;
wherein said rear seat section is pivotally in communication with said front seat section;
wherein said rear seat section is larger than said front seat section;
wherein said front seat section is configured to rest in a horizontal plane with said rear seat section;
wherein said front seat section is configured pivot to a different plane than said rear seat section;
wherein said front seat section is configured to move underneath said rear seat section;
wherein said rear seat section is configured to move forward and upward while said front seat section pivots at an angle;
wherein said rear seat section is supported by said front seat section and at least one stabilizing link;
wherein said arm rests are configured to rise along with said rear seat section;
wherein said at least one stabilizing link is configured to pivot; and
wherein said at least one stabilizing link is configured to rise along with said rear seat section.

2. A chair device, comprising:
a rear seat section;
a front seat section, in communication with said rear seat section;
a drive unit, in communication with at least one of the rear seat section and the front seat section, wherein said drive unit is configured to raise and lower said at least one of the rear seat section and the front seat section.

3. The chair device of claim 2, wherein said rear seat section is pivotally in communication with said front seat section.

4. The chair device of claim 2, wherein said rear seat section is larger than said front seat section.

5. The chair device of claim 2, further comprising left and right side plates of said rear section and left and right side plates of said front section, a top surface of said rear section between said left and right side plates of said rear section being recessed with respect to a top surface of said left and right side plates of said rear section, and a top surface of said front section between said left and right side plates of said front section being recessed with respect to a top surface of said left and right side plates of said front section.

6. The chair device of claim 5, wherein said left and right side plates of said rear section and left and right side plates of said front section each have a front top surface and a rear top surface elevated with respect to a central top surface of said left and right side plates of said rear section and said front section, and said left and right side plates of said front section have a front angled edge that eliminates pinching.

7. The chair device of claim 2, wherein said front seat section is configured to pivot to a different plane than said rear seat section.

8. The chair device of claim 2, wherein said front seat section is configured to move underneath said rear seat section.

9. The chair device of claim 2, wherein said rear seat section is configured to move forward and upward.

10. The chair device of claim 9, wherein said rear seat section is configured to move forward and upward via said drive unit.

11. The chair device of claim 2, wherein said rear seat section is supported by said front seat section and at least one stabilizing link.

12. The chair device of claim 11, wherein said at least one stabilizing link is configured to pivot.

13. The chair device of claim 11, wherein said at least one stabilizing link is configured to rise along with said rear seat section.

14. The chair device of claim 2, wherein said rear seat section is configured to move forward and upward while said front seat section pivots at an angle.

15. The chair device of claim 2, further comprising arm rests in communication with said rear seat section, wherein said arm rests are configured to rise along with said rear seat section.

16. The chair device of claim 2, further comprising a wedge unit configured to fit underneath and between said rear seat section and said front seat section.

17. A method of assisting an occupant to stand from a chair, the occupant having a pair of legs, the chair including a seat that has a front section and a rear section, the method comprising:
raising at least one of the front section and the rear section without tipping the chair;
rotating the front section about a pivot point such that a seating surface of the front section rotates down and away from a seating surface of the rear section;
supporting a weight of the occupant of the chair with the rear section; and
straightening the legs of the occupant of the chair while the occupant remains in an upright position such that a torso of the occupant is not tipped forward and the occupant of the chair achieves a free standing position unsupported by the chair,
wherein the occupant is not pinched by the chair when the occupant stands from the chair.

18. The method of claim 17, wherein
said front section includes left and right side plates,
said rear section includes left and right side plates,
a top surface of said rear section between said left and right side plates of said rear section is recessed with respect to a top surface of said left and right side plates of said rear section,
a top surface of said front section between said left and right side plates of said front section is recessed with respect to a top surface of said left and right side plates of said front section
said left and right side plates of said rear section each have a front top surface elevated with respect to a central top surface of said left and right side plates of said rear section,
said left and right side plates of said front section each have a front top surface and a rear top surface elevated with respect to a central top surface of said left and right side plates of said front section, and
said left and right side plates of said front section have a front angled edge that eliminates pinching.

19. The method of claim 17, further comprising:
moving the rear section forward and upward; and
moving the front section underneath the rear section,
wherein the chair includes a wedge mounted underneath and between the front and rear sections.

20. The method of claim 17, further comprising the occupant actuating a drive control on an arm rest of the chair to cause said raising the at least one of the front section and the rear section without tipping the chair.
